(19) United States
(12) Patent Application Publication
(10) Pub. No.: US 2018/0218143 A1
(43) Pub. Date: Aug. 2, 2018

(54) ELECTRONIC APPARATUS, AND NON-TRANSITORY COMPUTER READABLE RECORDING MEDIUM STORING LOCK MANAGING PROGRAM

(71) Applicant: KYOCERA Document Solutions Inc., Osaka (JP)

(72) Inventor: Hiroki Arakawa, Osaka (JP)

(73) Assignee: Kyocera Document Solutions

(21) Appl. No.: 15/877,222

(22) Filed: Jan. 22, 2018

(30) Foreign Application Priority Data
Jan. 30, 2017 (JP) 2017-014154

(51) Int. Cl. G06F 21/36; G06F 21/46; G06F 3/041; G06F 3/0481; G06F 3/0484; G06F 3/0488

(52) U.S. Cl. CPC G06F 21/36; G06F 21/46; G06F 3/0488; G06F 3/0481; G06F 3/0484; G06F 3/0412

(57) ABSTRACT

In an electronic apparatus, a display device displays an unlock screen that includes a mark pattern of one or plural marks. A touch panel (a) detects as one unlock operation a user operation performed at one time to a part or all of the one or plural marks and (b) is capable of detecting as a registered unlock operation pattern the unlock operations performed a preset number of times. A lock managing unit (a) displays the unlock screen on the display device in a lock status that restricts user operations, (b) determines user operations detected plural times by the touch panel, (c) determines whether the determined user operations of plural times agree with the registered unlock operation pattern or not, and (d) cancels the lock status if the determined user operations of plural times agree with the registered unlock operation pattern.

### CROSS-REFERENCE TO RELATED APPLICATIONS

This application relates to and claims priority rights from Japanese Patent Application No. 2017-014154, filed on Jan. 30, 2017, the entire disclosures of which are hereby incorporated by reference herein.

### BACKGROUND

1. Field of the Present Disclosure

The present disclosure relates to an electronic apparatus and a non-transitory computer readable recording medium storing a lock managing program.

2. Description of the Related Art

An electronic apparatus has a “pattern lock” function as a sort of a lock function to restrict user operations. In the pattern lock function, nine points are displayed and arranged in a matrix on a display device, moving a touching position of a fingertip is detected by a touch panel on the display device, and if a track of the touching position of the fingertip agrees with a predetermined unlock pattern that goes through the points, then a lock status is canceled, and otherwise, the lock status is not canceled.

In an information processing terminal, the unlock pattern is changed every time to make it difficult to guess the current unlock pattern on the basis of fingerprints left on a surface of the touch panel.

In an electronic apparatus, contactlessly detecting an unlock pattern is enabled by detecting a contactless movement a touching position of a fingertip in order to make it difficult to guess the current unlock pattern on the basis of fingerprints left on a surface of the touch panel.

In the aforementioned techniques, it is difficult to guess the current unlock pattern on the basis of fingerprints left on a surface of the touch panel. However, inputting the unlock pattern is one sequential movement of a fingertip, and therefore, it is easy to visually recognize all tracks of the fingertip that consist of the unlock pattern. Consequently, if another person peeks it, such person easily guesses the unlock pattern.

### SUMMARY

An electronic apparatus of an aspect of the present disclosure includes a display device, a touch panel, and a lock managing unit. The display device is configured to display an unlock screen that includes a mark pattern of one or plural marks. The touch panel is (a) configured to detect as one unlock operation a user operation performed at one time to a part or all of the one or plural marks and (b) capable of detecting as a registered unlock operation pattern the unlock operations performed a preset number of times. The lock managing unit is configured to (a) display the unlock screen on the display device in a lock status that restricts user operations, (b) determine user operations detected plural times by the touch panel, (c) determine whether the determined user operations of plural times agree with the registered unlock operation pattern or not, and (d) cancel the lock status if the determined user operations of plural times agree with the registered unlock operation pattern.

A non-transitory computer readable recording medium stores a lock managing program. The lock managing program causes a computer built in an electronic apparatus to act as a lock managing unit. The electronic apparatus includes (a) a display device configured to display an unlock screen that includes a mark pattern of one or plural marks, and (b) a touch panel (b1) configured to detect as one unlock operation a user operation performed at one time to a part or all of the one or plural marks and (b2) capable of detecting as a registered unlock operation pattern the unlock operations performed a preset number of times. The lock managing unit (a) displays the unlock screen on the display device in a lock status that restricts user operations, (b) determines user operations detected plural times by the touch panel, (c) determines whether the determined user operations of plural times agree with the registered unlock operation pattern or not, and (d) cancels the lock status if the determined user operations of plural times agree with the registered unlock operation pattern.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an electronic apparatus according to an embodiment of the present disclosure;

FIG. 2 shows a diagram that indicates an unlock screen displayed on the electronic apparatus 1 shown in FIG. 1;

FIG. 3 shows a diagram that explains directions of a user operation to marks in a mark pattern included in the unlock screen shown in FIG. 2;

FIG. 4 shows a diagram that indicates an example of a user operation to a mark pattern included in the unlock screen shown in FIG. 2;

FIG. 5 shows a diagram that indicates an example of a registered unlock operation pattern included in setting data 22 in the electronic apparatus 1 shown in FIG. 1; and

FIG. 6 shows a flowchart that explains a behavior of the electronic apparatus shown in FIG. 1.

### DETAILED DESCRIPTION

Hereinafter, an embodiment according to an aspect of the present disclosure will be explained with reference to drawings.

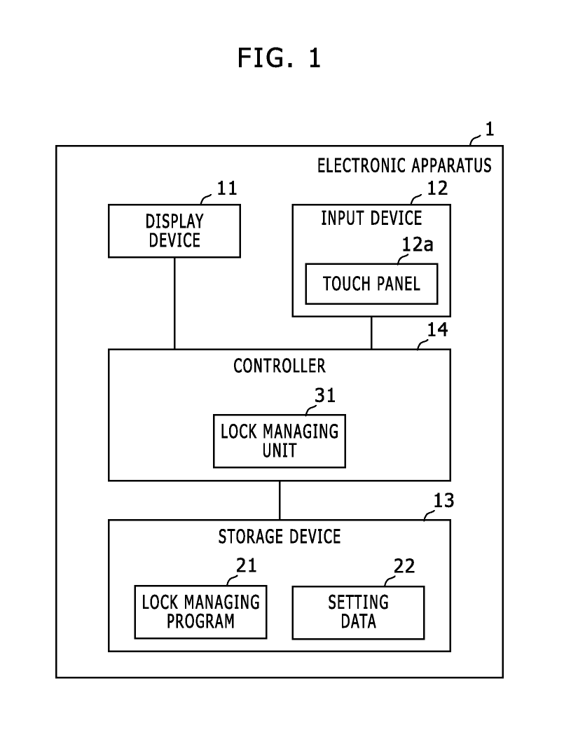

FIG. 1 shows a block diagram that indicates a configuration of an electronic apparatus according to an embodiment of the present disclosure.

The electronic apparatus 1 shown in FIG. 1 is, for example, a portable device such as smartphone or an image forming apparatus such as multi function peripheral, and includes a display device 11, an input device 12, a storage device 13, and a controller 14. The electronic apparatus 1 has a pattern lock function.

The display device 11 is an internal device such as a liquid crystal display, that displays an operation screen and the like for a user. The input device 12 is an internal device including a touch panel 12, that detects a user operation.

The display device 11 displays an unlock screen.

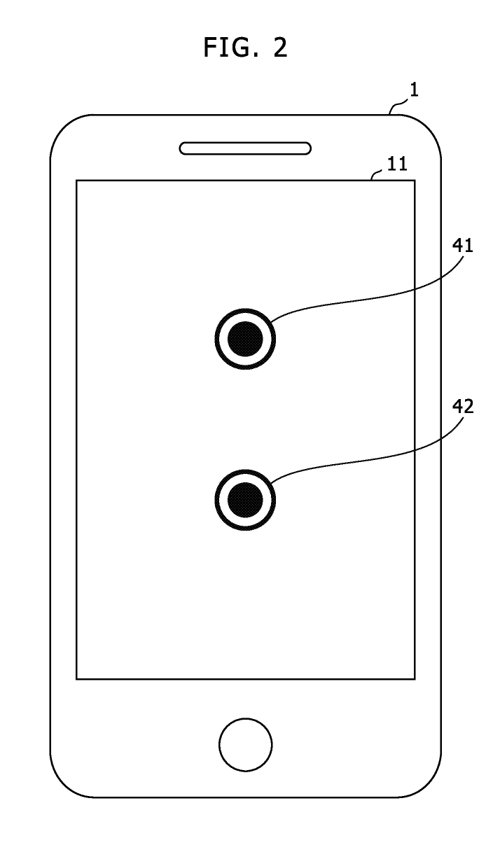

FIG. 2 shows a diagram that indicates an unlock screen displayed on the electronic apparatus 1 shown in FIG. 1. As shown in FIG. 2, the unlock screen includes a mark pattern that includes one or plural marks (in FIG. 2, two marks 41 and 42).

Each mark 41 or 42 indicates a starting point of a user operation. In this embodiment, a user operation to the marks 41 and 42 is any of operations: a flick operation, a swipe operation and a drag operation.

The touch panel 12a (a) detects as one unlock operation a user operation performed at one time to a part or all of the one or plural marks and (b) is capable of detecting as a registered unlock operation pattern the unlock operations performed a preset number of times.

The storage device 13 is a nonvolatile storage device such as a flash memory or a hard disk. A lock managing program 21, setting data 22 and the like are stored in the storage device 13. In the setting data 22, the aforementioned registered unlock operation pattern is included.

The controller 14 is a computer that includes a CPU (Central Processing Unit), a RAM (Random Access Memory), a ROM (Read Only Memory) and the like, and loads the lock managing program 21 to the RAM and executes the lock managing program 21 using the CPU, and thereby acts as a lock managing unit 31.

If a predetermined condition is satisfied, the lock managing unit 31 causes this electronic apparatus 1 to move to a lock status that restricts user operations. For example, in the lock status, the unlock screen is continuously displayed, and/or only an operation unit is displayed in the display device 11 for changing the display screen to the unlock screen.

The lock managing unit 31 (a) displays the aforementioned unlock screen on the display device 11 in the lock status, (b) determines user operations detected plural times by the touch panel 12a, (c) determines whether the determined user operations of plural times agree with the registered unlock operation pattern or not, and (d) cancels the lock status if the determined user operations of plural times agree with the registered unlock operation pattern. If the lock status is canceled, for example, the controller 14 causes the display device 11 to display an operation screen that enables a user to input user operations (i.e. other than the user operations to the mark pattern).

Here, a user operation to be inputted at each time in the registered unlock operation pattern as user operations of plural times (i.e. unlock operations) is specified as a user operation (e.g. flick, swipe, drag or the like) to a predetermined direction on each mark of a part or all of marks 41 and 42 that consist of a mark pattern.

If the aforementioned user operation is specified as a drag operation, when a contacting position of a user's fingertip (a position where contact to the touch panel 12a is detected) moves, the lock managing unit 31 moves a displaying position of the mark 41 or 42 from an original position to the contacting position, and when the contact of the fingertip is finished, the lock managing unit 31 returns the displaying position to the original position.

Therefore, the registered unlock operation pattern specifies whether a user operation is required or not (and a user operation direction when a user operation is required) for each mark in each time of user operations.

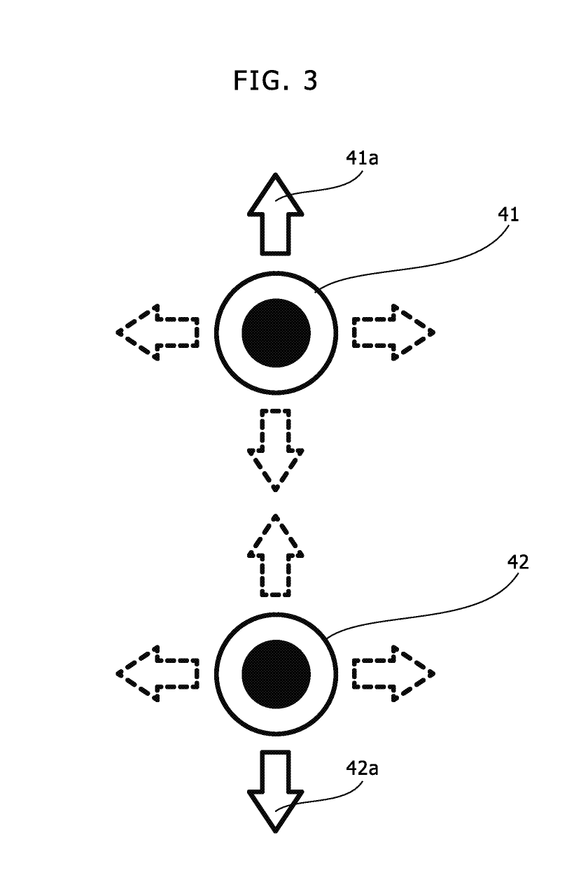

FIG. 3 shows a diagram that explains directions of a user operation to marks 41 and 42 in a mark pattern included in the unlock screen shown in FIG. 2. Here, the user operation direction is set as any one of predetermined directions (here, 4 directions). For example, as shown by solid line arrows in FIG. 3, for the mark 41, an upward operation direction 41a is specified as the user operation direction; and for the mark 42, a downward operation direction 42a is specified as the user operation direction.

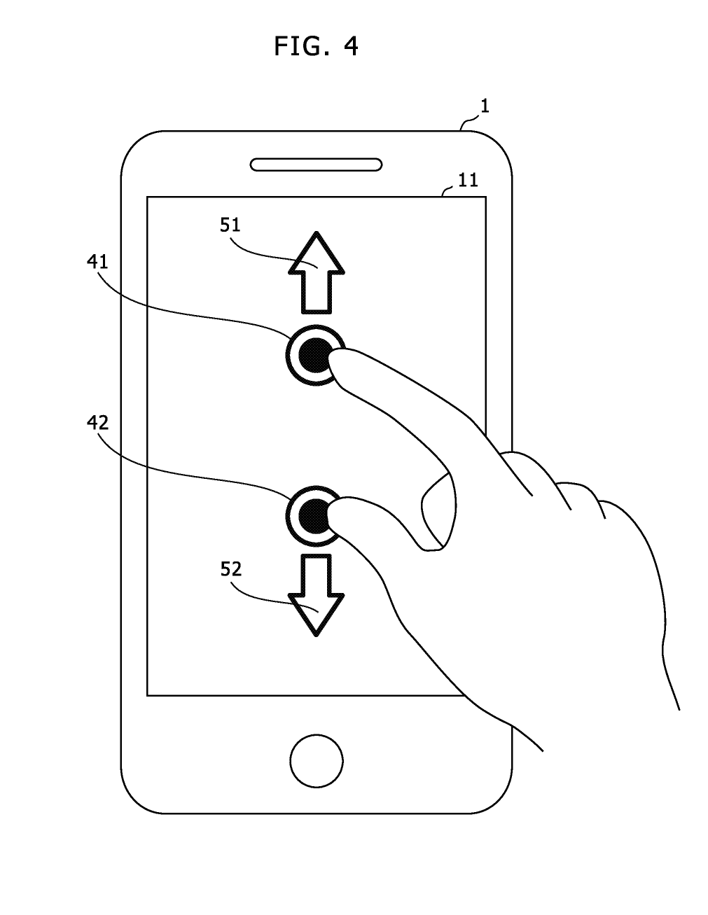

FIG. 4 shows a diagram that indicates an example of a user operation to a mark pattern included in the unlock screen shown in FIG. 2.

For example, when the upward operation direction 41a and the downward operation direction 42a are respectively specified to the marks 41 and 42 as the user operation directions in one user operation of one time in the registered unlock operation pattern, a user performs, as shown in FIG. 4, a swipe operation 51 to an upward direction from the mark 41 and a swipe operation 52 to a downward direction from the mark 42 at one time, and consequently, this actual user operation agrees with one user operation of one time in the registered unlock operation pattern.

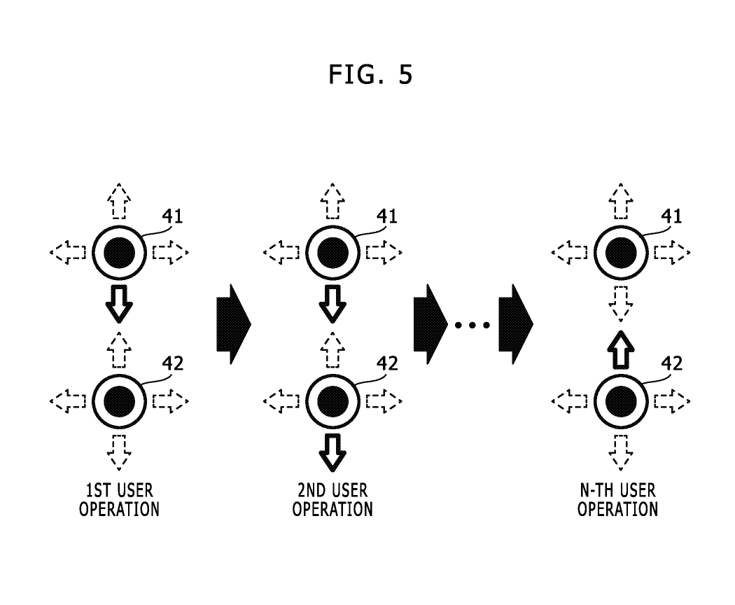

FIG. 5 shows a diagram that indicates an example of a registered unlock operation pattern included in setting data 22 in the electronic apparatus 1 shown in FIG. 1. As shown in FIG. 5, the registered unlock operation pattern includes continuous user operations of N times (N>1), and for each of the user operations and for each mark, includes (a) whether a user operation is required or not and (b) a user operation direction if the user operation is required.

For example, in a case shown in FIG. 5, for the first user operation, a downward user operation direction is specified to the mark 41 and no user operations are specified to the mark 42; for the second user operation, a downward user operation direction is specified to the mark 41 and a downward user operation direction is specified to the mark 42; and for the N th user operation, no user operations are specified to the mark 41 and an upward user operation direction is specified to the mark 42.

The lock managing unit 31 reads the registered unlock operation pattern in the setting data 22, and determines whether the determined user operations of plural times agree with the registered unlock operation pattern or not.

Further, in this embodiment, after detecting user operations of the aforementioned predetermined number of times (i.e. the number of user operation times N of the registered unlock operation pattern), the lock managing unit 31 (c) determines whether the determined user operations of plural times agree with the registered unlock operation pattern or not, and (d) cancels the lock status if the determined user operations of plural times agree with the registered unlock operation pattern. Thus, even if a wrong user operation is performed before the N th user operation, at that time, the lock managing unit 31 does not notify a user of a determination result that the user operations do not agree with the registered unlock operation pattern.

Further, in this embodiment, the unlock screen includes an operation number counter value (i.e. i (i=1, 2, . . . , N) of the i th user operation in FIG. 5) that indicates an operation number of the unlock operation to be inputted. The lock managing unit 31 increases the operation number counter value by 1 every time the user operation is detected, and even after it is determined that the determined user operations of plural times do not agree with the registered unlock operation pattern, the lock managing unit 31 increases the operation number counter value by 1 every time the user operation is detected, without canceling the lock status. Consequently, the number of user operation times N of the registered unlock operation pattern is not guessed easily.

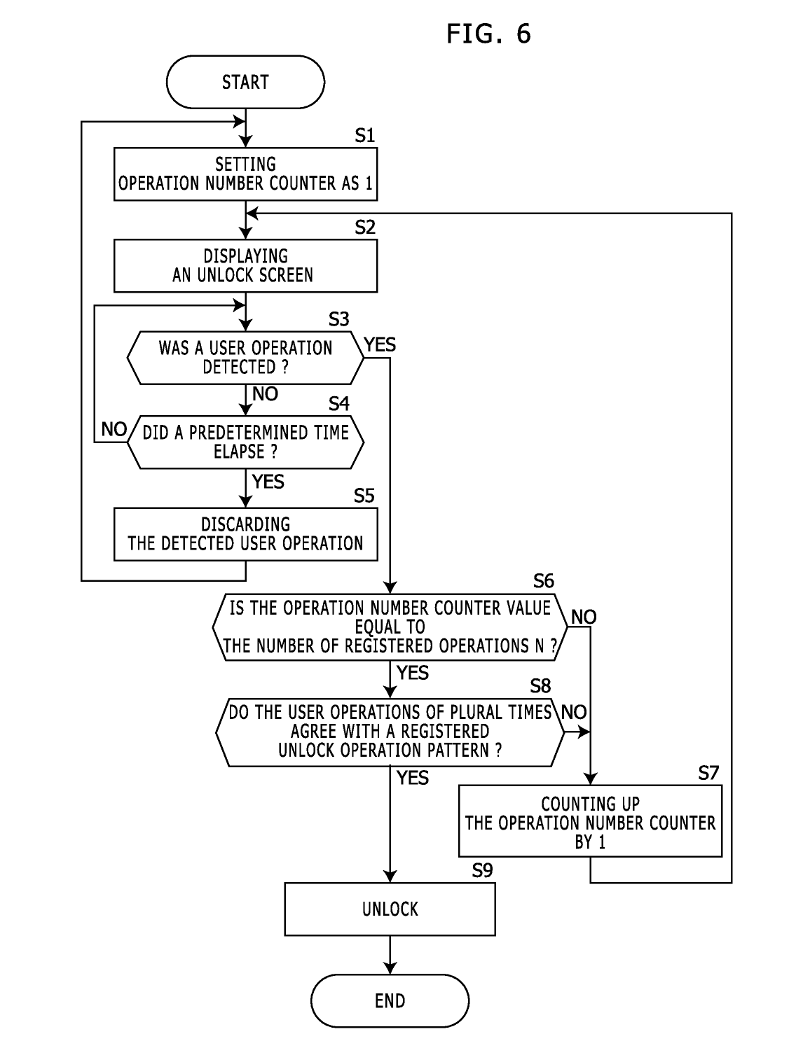

The following part explains the aforementioned electronic apparatus. FIG. 6 shows a flowchart that explains a behavior of the electronic apparatus shown in FIG. 1.

In the lock status, the lock managing unit 31 sets an operation number counter as 1, as an initial status of the unlock process (in Step S1), and causes the display device 11 to display the unlock screen (in Step S2).

Subsequently, the lock managing unit 31 watches (a) whether a user operation was detected by the touch panel 12a or not (in Step S3) and (b) whether a period in which no user operations are detected by the touch panel 12a (an elapsing time from a previous user operation, but before detecting the first user operation, an elapsing time from starting displaying the unlock screen) is equal to or longer than a predetermined time or not (in Step S4).

If it is determined that a period in which no user operations are detected by the touch panel 12a is equal to or longer than a predetermined time, then the lock managing unit 3 1 discards one or more user operations detected until the current time (in Step S5), and returning to Step S1, sets the operation number counter as 1 to return to the initial status.

Further, if a user operation is detected by the touch panel 12a before the predetermined time elapses, then the lock managing unit 31 determines whether the operation number counter value is equal to the number of user operation times N of the registered unlock operation pattern or not (in Step S6); and if the operation number counter value is not equal to the number of the user operation times N of the registered unlock operation pattern (including a case that the operation number counter value exceeds the number of the user operation times N), then the lock managing unit 31 increases the operation number counter value by 1 (in Step S7), and returning to Step S2, does not terminate displaying the unlock screen and watches the elapsing time and whether a next user operation is detected or not (in Steps S3 and S4).

Contrarily, if the operation number counter value is equal to the number of the user operation times N of the registered unlock operation pattern, then the lock managing unit 31 determines whether a user operation pattern continuously from the detected first user operation to the detected N th user operation agree with the registered unlock operation pattern or not (in Step S8).

If the user operation pattern continuously from the detected first user operation to the detected N th user operation agree with the registered unlock operation pattern, then the lock managing unit 31 cancels the lock status (in Step S9), and changes a screen displayed on the display device 11 from the unlock screen to a predetermined operation screen (e.g. a menu screen or the like).

Contrarily, if the user operation pattern continuously from the detected first user operation to the detected N th user operation do not agree with the registered unlock operation pattern, then the lock managing unit 31 increases the operation number counter value by 1 (in Step S7), and returning to Step S2, does not terminate displaying the unlock screen and watches the elapsing time and whether a next user operation is detected or not (in Steps S3 and S4). Consequently, displaying the unlock screen and the increment of the operation number are continued, and therefore, the number of the user operation times N of the registered unlock operation pattern is not guessed easily.

In the aforementioned embodiment, the display device 11 displays an unlock screen that includes a mark pattern of one or plural marks. The touch panel 12a (a) detects as one unlock operation a user operation performed at one time to a part or all of the one or plural marks and (b) is capable of detecting as a registered unlock operation pattern the unlock operation patterns performed a preset number of times. The lock managing unit 31 (a) displays the aforementioned unlock screen on the display device 11 in a lock status, (b) determines user operations detected plural times by the touch panel 12a, (c) determines whether the determined user operations of plural times agree with the registered unlock operation pattern or not, and (d) cancels the lock status if the determined user operations of plural times agree with the registered unlock operation pattern.

Consequently, the lock status is canceled on the basis of user operations of plural times and therefore if another person peeks it, such person does not easily guess the unlock operation pattern. Thus, it achieves high safety on the pattern lock.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, the number of the marks in the mark pattern is 2, but the number of the marks may be 1, 3 or more.

Further, in the aforementioned embodiment, a shape and a design (pattern) of the marks are not limited to those shown in FIG. 2 and the marks may have another shape and/or another design.

Furthermore, in the aforementioned embodiment, the registered unlock operation pattern in the setting data 22 may be enabled to be set and edited by a user.

What is claimed is:

1. An electronic apparatus, comprising:
a display device configured to display an unlock screen that includes a mark pattern of one or plural marks;
a touch panel (a) configured to detect as one unlock operation a user operation performed at one time to a part or all of the one or plural marks and (b) capable of detecting as a registered unlock operation pattern the unlock operations performed a preset number of times; and
a lock managing unit configured to (a) display the unlock screen on the display device in a lock status that restricts user operations, (b) determine user operations detected plural times by the touch panel, (c) determine whether the determined user operations of plural times agree with the registered unlock operation pattern or not, and (d) cancel the lock status if the determined user operations of plural times agree with the registered unlock operation pattern.

2. The electronic apparatus according to claim 1, wherein after detecting the user operations of plural times, the lock managing unit (c) determines whether the determined user operations of plural times agree with the registered unlock operation pattern or not, and (d) cancels the lock status if the determined user operations of plural times agree with the registered unlock operation pattern.

3. The electronic apparatus according to claim 1, wherein the unlock screen includes an operation number counter value that indicates an operation number of the unlock operation to be inputted; and
the lock managing unit increases the operation number counter value by 1 every time the user operation is detected;
further wherein even after it is determined that the determined user operations of plural times do not agree with the registered unlock operation pattern, the lock managing unit increases the operation number counter value by 1 every time the user operation is detected, without canceling the lock status.

4. The electronic apparatus according to claim 1, wherein the user operations are any of: flick operations, swipe operations, and drag operations.

5. A non-transitory computer readable recording medium storing a lock managing program, wherein the lock managing program causes a computer built in an electronic apparatus to act as a lock managing unit;
the electronic apparatus comprises (a) a display device configured to display an unlock screen that includes a mark pattern of one or plural marks, and (b) a touch panel (b1) configured to detect as one unlock operation a user operation performed at one time to a part or all of the one or plural marks and (b2) capable of detecting as a registered unlock operation pattern the unlock operations performed a preset number of times; and
the lock managing unit (a) displays the unlock screen on the display device in a lock status that restricts user operations, (b) determines user operations detected plural times by the touch panel, (c) determines whether the determined user operations of plural times agree with the registered unlock operation pattern or not, and (d) cancels the lock status if the determined user operations of plural times agree with the registered unlock operation pattern.
